(19) United States
(12) Patent Application Publication
(10) Pub. No.: US 2011/0087999 A1
(43) Pub. Date: Apr. 14, 2011

(54) Set definition in data processing systems

(75) Inventors: Patrik Bichsel, Zurich (CH); Franz-Stefan Preiss, Zurich (CH); Mario Verdicchio, Milano (IT)

(73) Assignee: International Business Machines Corporation, Armonk, NY (US)

(21) Appl. No.: 12/924,600

(22) Filed: Sep. 30, 2010

Related U.S. Application Data
(63) Continuation of application No. 11/484,406, filed on Jul. 11, 2006, now Pat. No. 7,684,534.

(30) Foreign Application Priority Data
Sep. 30, 2009 (EP) 09171833.8

(51) Int. Cl. G06F 3/048

(52) U.S. Cl. 715/845

(57) ABSTRACT

The invention defines sets of items in a data processing system where the items can be visually represented in a graphical user interface by respective graphical elements which are individually selectable via the graphical user interface to permit indication by a user of items on which actions are to be performed in the system. A graphical device, which identifies the graphical elements corresponding to items in the set, is generated. The device is independent of the selection state of the elements, which remain individually selectable, and the set of items is independently selectable to permit actions to be performed on the set of items in the system. Set data defining the set of items is stored. The methods and apparatus allow the same item to be a member concurrently of more than one set for which the respective graphical devices concurrently identifies the graphical element corresponding to that item.

### FIELD OF THE INVENTION

This invention relates generally to definition of sets of items in data processing systems where the items in question can be visually represented by graphical elements in a graphical user interface of the system. Methods, apparatus and computer programs are provided for defining such sets, together with data processing systems employing these.

### BACKGROUND OF THE INVENTION

Most data processing systems, including devices such as general purpose computers and PDAs (personal digital assistants), mobile phones, music players etc., make use of a graphical use interface (GUI) to facilitate user interactions with the system. The GUI provides an interactive user environment in which the user can control system operations and system information can be presented to the user. GUIs employ a visual display together with some form of pointing/selecting tool, controlled by an input mechanism, via which a user can manipulate displayed features. In particular, graphical elements in the display are used to represent items, or objects, stored in system memory, such as program files, text files, audio files, etc., on which operations can be performed in the system. These graphical elements, which may be icons, thumbnails, textual elements, etc., are individually selectable by a user via the GUI to permit indication by the user of items on which actions are to be performed in the system. The user can select an element using the pointing/selecting mechanism, for example by “clicking” on an element using a mouse/pointer system or touching an element in a touch-sensitive screen system. When selected, a graphical element is usually highlighted in some manner, e.g. by shading with a different colour, to distinguish the selected state from the unselected state of the element. Actions which can be performed on the item represented by a selected element are also selectable via the GUI, for example via a pull-down menu.

If a user wishes to perform some action on more than one item, the set of items can be defined by selecting the elements corresponding to those items in the GUI. Current operating systems provide substantially the same mechanisms for doing this. According to the common basic paradigm, a set is created either by highlighting a zone on the screen containing the relevant elements, by selecting the elements one at a time while pressing a specific button on the keyboard, or by using built-in functions (e.g. “select all” and “invert selection” functions) in the system. The set is represented by its own members whose elements are, in the selected state, visually distinguishable from their usual (unselected) form as described above. In this way, elements corresponding to items contained in the set are distinguished from elements representing items not contained in the set.

The established system for defining sets of items has a number of limitations. One problem is volatility. Specifically, every action performed within the GUI which is not related to the set itself discards the set. It is not possible to preserve the set and access at the same time the properties of other items to check, for instance, whether they should be added to the set on the basis of some specific criterion. Another problem is that of “element hiding”: once a set is created, the user loses access to the individual members of the set because the selection state of the elements is used to indicate set membership. As a consequence, certain actions (e.g. “copy”, “properties”, etc.) that can be applied to the set cannot be applied to the individual items in the set. Another problem is “set uniqueness”: only one set at a time can be managed. Since elements have only two selection states, selected and unselected, at most one explicitly-visualized set containing all the selected items can exist. The attempt to create another set automatically discards the first, so it is impossible for more than one set to exist concurrently.

Other, functionally different mechanisms exist for creating sets in data processing systems, in particular file systems and file labelling mechanisms. The file system provides the mechanisms for storing and organizing data items and typically utilizes a hierarchical data structure in which files (both program and data files) are stored in folders and any given file is usually referenced by only one link. A group of folders can be contained in a single folder in a higher level of the hierarchy. A given folder typically opens in a window of the GUI which contains graphical elements corresponding to the items contained in that folder. Labelling systems allow labels to be associated with files, whereby a subsequent search under a particular file label identifies all files to which that label has been attached. Another functionally different mechanism involving representation of some type of set is the “grouping” function in some graphics applications. This function allows groups of drawing components to be “stuck together” to form a single component which can then be manipulated as such in the image. A similar type of mechanism is disclosed in U.S. Pat. No. 6,857,106, whereby groups of icons can be stuck together to form unitary components, here to allow users to design the appearance of a GUI. These various other systems for defining sets are quite different in nature to the system described earlier for defining sets of items on which some action is to be performed by selecting the corresponding graphical elements in the GUI.

### SUMMARY OF THE INVENTION

One aspect of the present invention provides a method for defining sets of items in a data processing system, the items being visually represented in a graphical user interface of the system by respective graphical elements which are individually selectable via the graphical user interface to permit indication by a user of items on which actions are to be performed in the system. The method comprises steps for receiving via a graphical user interface an indication of the graphical elements corresponding to items to be included in a set; generating in the graphical user interface a graphical device which identifies the graphical elements corresponding to items in the set, the device being independent of the selection state of the elements, which remain individually selectable, and the set of items being independently selectable via the graphical user interface to permit actions to be performed on the set of items in the system; and storing in the system set data defining the set of items; the method being such that the same item can be a member concurrently of more than one set for which the respective graphical devices concurrently identify the graphical element corresponding to that item.

A second aspect of the invention provides a computer program comprising program code means for causing a computer to perform a method according to the first aspect of the invention. It will be understood that the term “computer” is used in the most general sense and includes any device, component or system having a data processing capability for implementing a computer program. Moreover, a computer program embodying the invention may constitute an independent program or may be an element of a larger program, and may be supplied, for example, embodied in a computer-readable medium such as a disk or an electronic transmission for loading in a computer. The program code means of the computer program may comprise any expression, in any language, code or notation, of a set of instructions intended to cause a computer to perform the method in question, either directly or after either or both of (a) conversion to another language, code or notation, and (b) reproduction in a different material form.

A third aspect of the invention provides apparatus for defining sets of items in a data processing system, the items being visually represented in a graphical user interface of the system by respective graphical elements which are individually selectable via the graphical user interface to permit indication by a user of items on which actions are to be performed in the system. The apparatus comprises memory and set management logic adapted for performing steps of receiving via the graphical user interface an indication of the graphical elements corresponding to items to be included in a set; generating in the graphical user interface a graphical device which identifies the graphical elements corresponding to items in the set, the device being independent of the selection state of the elements, which remain individually selectable, and the set of items being independently selectable via the graphical user interface to permit actions to be performed on the set of items in the system; and storing in said memory set data defining the set of items; wherein the set management logic is adapted such that the same item can be a member concurrently of more than one said set for which the respective graphical devices concurrently identify the graphical element corresponding to that item.

A fourth aspect of the invention provides a data processing system comprising memory, a display for displaying a graphical user interface, control logic for controlling the graphical user interface such that items stored in said memory are visually represented in the graphical user interface by respective graphical elements which are individually selectable via the interface to permit indication by a user of items on which actions are to be performed in the data processing system, and an input system for user input to interact with the graphical user interface. The control logic includes set management logic for defining sets of items represented by elements in the graphical user interface, the set management logic being adapted for receiving via the graphical user interface an indication of the graphical elements corresponding to items to be included in a set; generating in the graphical user interface a graphical device which identifies the graphical elements corresponding to items in the set, the device being independent of the selection state of the elements, which remain individually selectable, and the set of items being independently selectable via the graphical user interface to permit actions to be performed on the set of items in the system; and storing in said memory set data defining the set of items; wherein the set management logic is adapted such that the same item can be a member concurrently of more than one said set for which the respective graphical devices concurrently identify the graphical element corresponding to that item.

In general, where features are described herein with reference to an embodiment of one aspect of the invention, corresponding features may be provided in embodiments of another aspect of the invention.

### BRIEF DESCRIPTION OF THE DRAWINGS

Preferred embodiments of the invention will now be described, by way of example, with reference to the accompanying drawings in which:

FIG. 1 is a schematic representation of a data processing system embodying the invention;

FIG. 2 illustrates a part of the displayed image in a graphical user interface of the FIG. 1 system;

FIG. 3 shows key steps in a set definition process performed in the system;

FIG. 4 illustrates representation of a set in the graphical user interface in a first embodiment of the set definition process of FIG. 3;

FIG. 5 illustrates accessing of set-related functions in the example of FIG. 4;

FIGS. 6 and 7 illustrate different techniques for adding items to the set in the example of FIG. 4;

FIGS. 8a and 8b illustrate variations to the technique of FIG. 7;

FIGS. 9a to 9d illustrate removal of an item from a set with the FIG. 7 technique;

FIG. 10 illustrates concurrent overlapping sets in a GUI;

FIG. 11 illustrates representation of a set in the GUI in a second embodiment of the set definition process of FIG. 3;

FIG. 12 illustrates concurrent overlapping sets with the system of FIG. 11; and

FIG. 13 illustrates representation of a set including items whose corresponding graphical elements are not currently viewable in the GUI.

### DETAILED DESCRIPTION OF THE INVENTION

In methods embodying this invention, sets of items on which actions are to be performed in a data processing system are defined and represented in a GUI independently of the graphical elements representing those items. More particularly, sets are defined and represented independently of the selection state of the elements representing items in those sets. The elements themselves thus remain individually selectable in the GUI. The set is visually represented in the GUI by a graphical device which identifies the elements corresponding to items in the set, independently of element selection-state as aforesaid, and the set is selectable independently of the individual elements to permit actions to be performed on the set.

By recognizing the problems with the conventional system, and moreover that those problems stem primarily from use of the element selection state to represent sets, methods embodying this invention provide a solution to these problems via the elegantly simple mechanism just described. The element hiding problem is overcome because access to individual elements is possible without discarding the set. The volatility problem is likewise solved, the set being selectable independently of the individual elements so that sets are allowed to be persistent and the user can perform other actions without discarding the set. The set uniqueness problem is obviated because set persistence allows more than one set to exist concurrently and, since more than one set can be depicted, an item can be a member of more than one set. Specifically, in methods embodying the invention the same item can be a member concurrently of more than one set, and their respective graphical devices then concurrently identify the same graphical element, i.e. the element representing the common item. Thus, the graphical devices which represent sets in the GUI are such that “overlapping” sets can be depicted, and any single graphical element can be indicated as being in a plurality of sets at the same time. This is quite different, for example, from the representation of files in a hierarchically organized file system. Indeed, the definition of sets in embodiments of the invention is quite independent of any hierarchical ordering of items in the file system, and offers an additional level of organizational functionality over and above the file system. Overall, therefore, embodiments of the invention provide elegantly simple yet significantly improved set definition systems which greatly expand the limited functionality of the conventional approach.

To enable actions to be performed on the set of items in the system, the set is conveniently selectable via the GUI by selecting the graphical device itself. Hence, the graphical device is preferably selectable via the GUI independently of the elements themselves to permit actions to be performed on the set of items as a whole. Alternatively or in addition, however, the set could be selectable via other mechanisms in the GUI, e.g. via menus accessible, for instance, from function bars in the GUI.

When creating a set in embodiments of the invention, a user may indicate the graphical elements corresponding to items to be included in the set in a variety of ways via the GUI. For example, the user could simply select the elements in the usual way, e.g. by clicking, or could indicate in some manner a region of the display which contains the elements in question. Examples will be described in more detail below. In response (whether directly, triggered by element selection, or indirectly after explicit indication of the intention to create a set), the graphical device representing the set is generated in the GUI. This device identifies the elements in the GUI corresponding to items included in the set. The graphical device could take a variety of forms and could identify elements in various ways so as to distinguish the included elements from elements excluded from the set representation. In general, the device could be a unitary device or a composite device made up of a plurality of depicted features, and may comprise pictorial, textual or numerical features or any combination thereof. The graphical elements representing items may comprise, for example, icons, thumbnails, textual elements, etc. Again, these elements may in general comprise pictorial, textual, or numerical matter or any combination of these. The items themselves may comprise (one or more) files, whether program files or data files, or parts thereof, and could in general be any item which is represented in the GUI by a graphical element.

In particularly preferred embodiments, the graphical device representing a set comprises a frame extending around the elements corresponding to items in the set. With this simple device, set membership is identified by location of the elements within the frame. (Note that such a frame need not necessarily extend entirely around the elements, but just sufficiently to distinguish included elements from those excluded from the frame). Such frames provide a highly intuitive mechanism for visualising and manipulating sets. For example, changing set membership can be particularly easy with a frame-based system. This will be discussed in more detail below.

In other preferred embodiments, the graphical device comprises respective graphical indicators associated with the elements corresponding to items in the set. Each indicator identifies a given element as “contained in” the set. Possible examples include marking elements with a particular number, shape, colour, etc. to indicate set membership. However, in a preferred embodiment described below, such an indicator comprises a frame extending around an individual element. This form of device may also include other features, e.g. a selectable feature for the set which may be connected to (or otherwise associated with) the individual element indicators.

The set data which is stored in the system may define the set in any appropriate manner, but typically comprises a set identifier for the set and an item identifier for each item included in the set. Depending on the particular application, the stored set data may be maintained on shut-down of the data processing system, or the set data may be discarded on system shut-down. In the latter case, the sets are not fully persistent but persist (at most) only for the duration of an operating session.

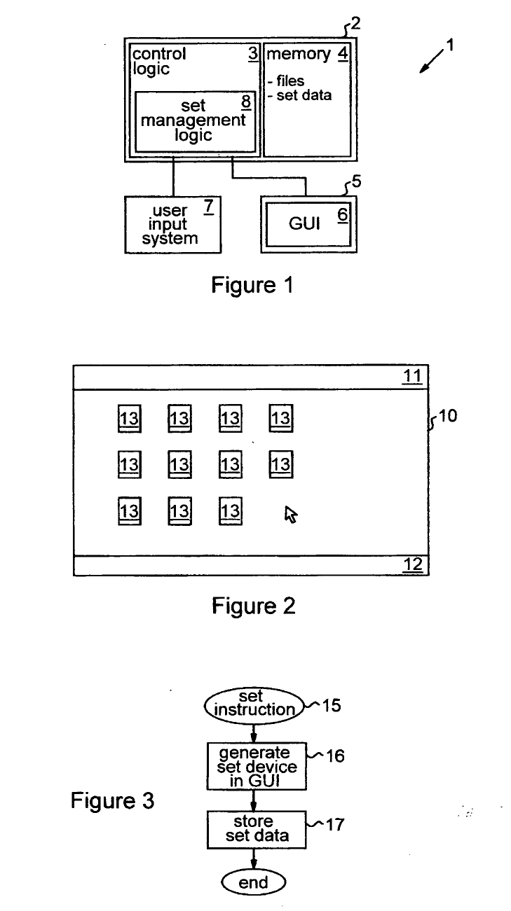

The block diagram of FIG. 1 illustrates one example of a data processing system embodying the invention and shows the main components involved in operation of the set definition process to be described. The system 1 includes processing apparatus 2 comprising control logic 3 and memory 4. Control logic 3 controls operation of the system generally. This functionality includes control of a graphical user interface which is visually represented on a display 5 of system 1 as indicated schematically at 6 in the figure. A user input system is represented by block 7 in the figure. Input system 7 includes one or more devices and/or other mechanisms via which a user can interact with GUI 6 and provide input to the system generally. Depending on the particular nature and function of apparatus 2, the input system might comprise, for example, a mouse, touchpad or other pointer control, a keypad, keyboard or other button-based mechanism, a voice-activated control system and/or a touch-sensitive screen system. Hence, while input system 7 is represented by a separate block in the figure, in practice this may be wholly or partly integrated with display 5. It will also be understood that, while the GUI is represented in the figure by the displayed image 6, the concept of a GUI extends beyond its purely visual representation, encompassing underlying logic mechanisms which relate displayed features to functionality of apparatus 2 and the operation of user input system 7.

Memory 4 stores program and data files used by system 1. These are organized in accordance with a file system, typically based on some form of hierarchical data structure, which is managed by control logic 3. Though represented by a single block in the figure, memory 4 may comprise one or more memory units incorporating different memory-types, including working memory such as RAM (random access memory) and persistent storage such as HD (hard disk) storage. Memory 4 also stores other data generated in operation of system 1, including general working data as well as set data which is generated in the set definition process to be described. In particular, control logic 3 includes set management logic 8 which controls the set definition process detailed below and maintains the set data in memory 4. In general, logic 3, 8 could be implemented in hardware, software or a combination thereof. In this example, however, the control logic is implemented by software which causes a computer to perform the described functions and suitable software will be apparent to those skilled in the art from the description herein. For the purposes of this example, it is assumed in the following that system 1 is implemented by a general-purpose PC (personal computer) with a mouse and keyboard providing user input system 7.

In operation of system 1, data items (such as files and components of files) stored in memory 4 on which actions may be performed in the system under user control can be represented in GUI 6. In particular, control logic 3 controls GUI 6 such that items available to a user in a current screen view are visually represented by respective graphical elements in the GUI. By way of example, FIG. 2 is a schematic illustration of a typical window in the GUI display. Window 10 has upper and lower function bars 11, 12 which typically provide access, via screen buttons or pull-down menus, to actions available to the user. Here, files which can be accessed from window 10 are represented by graphical elements in the form of respective icons 13. Icons 13 may, for instance, represent document or picture files in the folder window of a document or picture manager application. In any case, each icon 13 is individually selectable in the GUI in the usual manner, e.g. by clicking on the icon using the mouse and on-screen cursor, to permit indication by the user of files on which some action is to be performed. However, if the user wishes to specify a plurality of items on which actions can be performed as a set, then set management logic 8 provides particular functionality to support this. Specifically, set management logic 8 implements a process for defining sets of items, here files represented by icons 13, when required. The main steps of the process are shown in the flow chart of FIG. 3.

The set definition process is initiated when logic 8 receives an instruction via the GUI that the user wishes to create a new set. This set instruction, which can be input via the GUI in a variety of ways as discussed further below, comprises an indication of the graphical elements corresponding to items to be included in the set. Receipt of the set instruction is represented by initial block 15 in FIG. 3. In response, the set management logic 8 generates a graphical device representing the set in the GUI as indicated at step 16. This set device identifies the graphical elements in the GUI which correspond to items included in the set. The set device is independent of the selection state of the elements which remain individually selectable in the GUI. The device itself is also independently selectable via the GUI to permit actions to be performed on the set of items in the system. Examples of preferred forms for the set device will be described below. Next, in step 17 of FIG. 3, the set management logic generates set data defining the newly-created set and stores this set data in memory 4. The set data here includes some form of set identifier which can be assigned by logic 8, together with respective identifiers, e.g. file IDs, for the items included in the set. Logic 8 may also include functionality for assigning properties to sets in response to user input relating to the set, in which case these properties can be stored as part of the set data. Such a property might be, for instance, a user-assigned name for the set. In any case, in this embodiment the set data is stored in memory 4 as working data which will be discarded on shut-down of PC 1. In this example, therefore, the set data is maintained, and a given set persists, only for the duration of the current operating session (unless discarded earlier in response to user instruction). Once the set data has been stored in memory 4, the set definition process is complete.

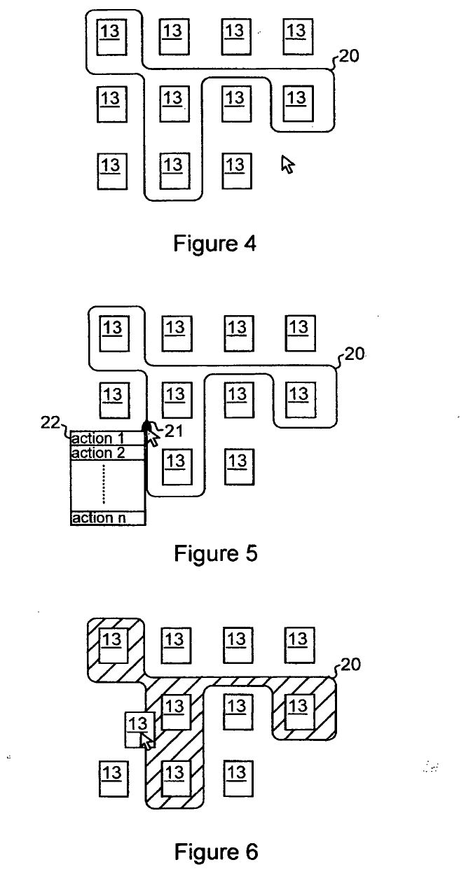

FIG. 4 illustrates a particularly preferred form for the set representation device generated in step 16 of FIG. 3. This set device takes the form of a frame 20 surrounding the icons 13 corresponding to items included in the set. The frame 20 appears in GUI 6 as a contour-shaped line along an icon's profile leaving a visible gap. Thus, set membership here is indicated by the position of icons 13 relative to the frame 20. Items whose corresponding icons are outside the frame are not included in the set. The user instruction to create the set and generate frame 20 could be input via the GUI in a variety of ways. The frame could be generated click-by-click: while the user clicks on multiple icons holding the control key (“Ctrl”) down, a frame is drawn and expands click-by-click to include each newly-selected icon. Alternatively, after selecting all the icons needed, the user could “right-click” on a selected icon and select a “create set” function from a pull-down menu, whereupon the frame appears. As a further example, the user could click and hold the mouse button down to drag the pointer, drawing a line surrounding the icons that are to form the set. Once the line is closed it is then replaced by a frame generated automatically by logic 8. (With this method, icons whose surface areas are totally included in the closed line, or partially included to a proportion above a predetermined threshold (e.g. 70%), are inserted in the set). This method is particularly advantageous in touch-screen systems. The set management logic 8 may also allow the user to select the default set-creation behaviour so that sets may be created whenever a user selects a set of elements or only created after selecting an explicit “set-creation” function.

Since frame 20 is independent of the selection state of icons 13, the icons can still be individually selected, e.g. to check properties or perform other actions, while the frame persists. In addition, the frame is independently selectable to perform set-related actions. In this example, as the on-screen pointer is moved within a preset threshold distance of frame 20, the closest portion of the frame widens to facilitate clicking on the frame to select the set.

The widened portion is called a facilitator, and disappears as the pointer is moved away again. As illustrated in FIG. 5, right-clicking on a facilitator 21 causes logic 8 to display a menu 22 showing available set-related actions. These actions are available in addition to the actions on individual items, and may be varied as appropriate in the context of the operating system or specific application. Typical examples might include:

delete—deletion of all items in the set, including the removal of the frame itself:

discard—deletion of the frame without deleting the items in the set;

open—activation of the items in the set;

expand—include an item or another set in the current set;

reduce—remove items from the current set;

show—opening of a separate area (e.g. a new window) depicting all items in the set;

re-arrange—change the arrangement of icons such that they are optimally placed (e.g. adjacent);

tag—append a tag to a set, e.g. a name or date;

as well as familiar actions like “cut” and “copy” and any application-specific actions.

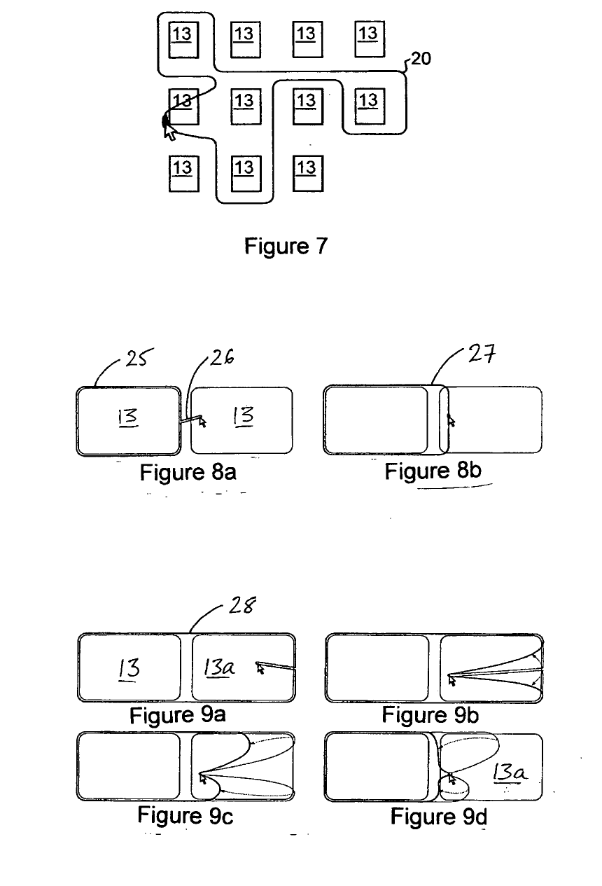

The frame paradigm provides a particularly intuitive system for the representation and management of sets. For example, icon-based activation is a prominent feature of the frame-paradigm, allowing for a more direct and intuitive way to achieve set modifications. In particular, items can be added to or removed from a set by dragging and dropping icons into or out of the frame. This is illustrated in FIG. 6. In response, set management logic 8 modifies the set data stored in memory 4 to redefine the set so that it contains those items corresponding to the changed set of icons in the frame. Alternatively or in addition, set membership might be changed in response to a user selecting and dragging the frame 20 to encompass or exclude an icon. This “pinch-and-pull” technique is illustrated in FIG. 7, the user “pinching” (selecting) and pulling (dragging) the frame which changes shape accordingly. Again, logic 8 will modify the set data to reflect the resulting change. FIG. 8a shows an alternative representation of the pinch-and-pull technique in which dragging of a selected frame 25 pulls a connector 26 out of the frame. When this is released with the end of the connector over another (here adjacent) icon 13, the frame is expanded to include that icon. As another example of the pinch-and-pull method, a section or side of a frame could be dragged to include/exclude an icon as illustrated in FIG. 8b for a frame 27. FIGS. 9a to 9d illustrate a process of removing an icon 13a from a frame 28 using the pinch-and-pull technique. These figures show successive stages in one example of this process, starting with pulling a connector inwardly of the frame in FIG. 9a. After crossing a preset threshold proportion (e.g. 70%) of icon 13a, the frame uncovers the item as depicted in the series from FIG. 9b to FIG. 9d. In general, particularly with more complex frame shapes, the new set of icons may be rearranged by logic 8 to minimize a frame's surface and perimeter when an icon is included or excluded.

Set management functions, including adding or removing items, can also be based on selecting actions associated with individual icons as well as actions associated with the frame. For example, an item could be added by accessing the set functionalities (e.g. via the set menu as in FIG. 5), selecting the proper action and then the icon for the item to be added (set-menu-based activation). Action selection could also be performed from the item's functionalities, e.g. via a menu called from the icon, and then selecting the set to which the item should be added (item-menu-based activation). The item functionalities will be added to existing actions provided by the underlying application.

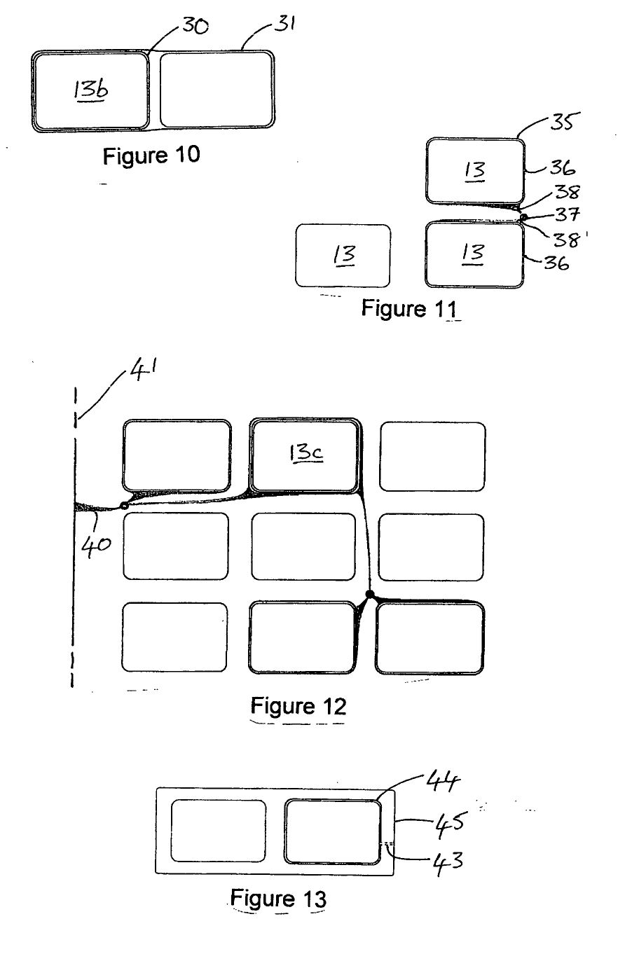

Since frames are persistent, multiple sets can be defined and represented concurrently in system 1. Moreover, any given item may be a member of more than one set. In this case, the icon representing that item can be contained in the frame of more than one set. FIG. 10 illustrates an exemplary representation of concurrent overlapping sets in a GUI of a system embodying the invention. In this simple example, an icon 13b is concurrently contained in an inner frame 30 and an outer frame 31, the latter frame also containing an adjacent icon. In general with overlapping frames, decisions about which frame is the inner and which the outer could be made by logic 8 based on which set existed first or based on optimizing appearance (e.g. minimizing the number of crossing frames). In any case, a frame drawn around an icon in an already-existing frame takes the modified profile (icon plus frame) into account, so leaving a visible gap between frames. Note that concurrent frames will typically be shown in different colours to make set membership more clearly identifiable to the user. It will also be appreciated that partially-overlapping sets are permitted in this system. That is, the same item can be a member concurrently of more than one set none of which is a subset of the other. Hence, concurrent frames need not be nested one inside another, but each can contain icons not contained in the other.

At least when the frame for more than one set is viewable in GUI 6, logic 8 highlights a given frame in the GUI in response to selection of that frame by the user so as to distinguish selected from non-selected frames. FIG. 6 illustrates an example of frame-highlighting, frame 20 being shown highlighted by shading in a different colour than usual. Similarly, while an item is being dragged, frames can be dynamically highlighted and de-highlighted by logic 8 to avoid ambiguity about which set is going to receive an item. In general, therefore, logic 8 can highlight a given frame in response to user interaction via the GUI with the set corresponding to that frame.

Where multiple sets are defined, standard set-theoretical functions (e.g., union, intersection, difference, etc.,) can be performed by logic 8 for specified sets. These actions can be called, for example, by selecting a frame and selecting the desired function from the set menu.

FIG. 11 illustrates representation of a set in the GUI in a second embodiment of the set definition process of FIG. 3. In this embodiment, the device 35 representing a set includes respective graphical indicators associated with the icons corresponding to items in the set. In particular, the device 35 includes individual frames 36 around the associated icons. Device 35 further includes a selectable symbol, here in the form of a ball-icon 37, for the set. The ball-icon is joined to icon frames 36 by flared connectors 38 to more clearly indicate the icons which are part of the set. All device features, i.e. frames 36, ball-icon 37 and connectors 38, are ideally coloured in the same colour.

With device 35, item and set actions can be performed in substantially the same manner as with the frame representation described earlier. For example, adding or removing items from sets can be performed by dragging icons or devices. Specifically, to add an item to a set, its icon can be dragged and dropped onto the ball-icon 37 for the set. The same action is performed to remove an item, but since the item was previously included the action removes the item and the frame and connector for the icon will be removed from the GUI by logic 8. The pinch-and-pull functionality described above can be used to add an item here by dragging a connector out of the ball-icon onto the icon to be added. An item can be removed by dragging the flared connector 38 for that icon towards the ball-icon, whereupon logic 8 deletes the icon's frame and adjusts the set contents accordingly. Since the ball-icon gives access to set-related actions, with this type of device logic 8 preferably moves the ball-icon in the GUI to prevent this icon from moving out of view as the user scrolls across a depicted set. The ball-icon is thus always visible while any icons in the set are within the current view.

Multiple concurrent sets can again be represented with the set device of FIG. 11. FIG. 12 shows an example of concurrent overlapping sets with this system, where icon 13c is included in both set devices shown. (In practice the different set devices will be displayed in different colours in the GUI for clarity). Note here that one of the set devices includes a flare connector 40 extending from the ball-icon to the closest edge of the current window as indicated at 41. This mechanism is used by logic 8 to adapt a set device to indicate that the set in question includes items whose corresponding icons are not currently viewable in the GUI. Such a situation may arise, for example, when items in the set are not part of a currently-viewable folder or a current search result. By clicking on connector 40, the user gains access to the items not currently viewable, the corresponding icons then being displayed by logic 8. FIG. 13 shows a corresponding feature in the frame representation of the first embodiment described above. Here a dotted connector 43 is shown extending from a frame 44 to the closest edge of window 45, signifying that the set includes items not represented in the current view.

It will be seen that the foregoing embodiments provide simple, efficient systems for the definition and management of sets which significantly improve upon the conventional approach. Moreover, embodiments of the invention offer an additional layer of organizational control which is flexible enough to provide an effective complement to existing file systems and label-based functionality. Unlike file systems, however, embodiments of the invention allow sets to be created independently of hierarchical structures so that items can be inserted into more than one set without the need for system calls to create additional links to files.

It will be appreciated that many changes and modifications can be made to the exemplary embodiments described above. For example, while the system 1 is embodied in a personal computer in this example, embodiments of the invention could be implemented in numerous other data processing systems, from individual devices such as mobile phones, PDAs and music players, to distributed computer systems. In general, therefore, a data processing system embodying the invention may comprise one or more devices and the functionality described may be distributed over several component devices.

While the above example refers specifically to icons representing files in system 1, various other graphical elements representing items can be envisaged. Graphical elements may comprise thumbnails or textual elements for example, and in general the graphical element representing a given item could comprise one or more components. The items themselves could in general be any item which is represented by a graphical element in the GUI, and such an item may in general comprise one or more components.

While sets are formed of files represented by respective selectable icons in the simple examples described, in practice sets may also include items which are not represented by selectable elements in the GUI in addition to items with corresponding selectable elements in the GUI. A particular example here is where a given file has an associated folder containing metadata for that file. The file folder and metadata folder may be represented by respective icons in the GUI, but the metadata folder may not be selectable in isolation. Rather, selection of the file folder automatically selects its associated metadata folder. The file and associated metadata folder will thus be included in a set by logic 8 if the user selects the file's icon when creating a set.

The systems described can be readily adapted to support management of sets in a three-dimensional GUI. A frame, for example, can be visualised not only as a two-dimensional border, but also as a three-dimensional enclosure surrounding the relevant graphical elements. The various other features described can be easily applied to a three-dimensional environment in a straightforward way.

While the set data stored in memory 4 is discarded on shut-down in the examples described, applications can be envisaged where it may be desirable for set data to be maintained in persistent storage so that sets persist through a system shut-down. For such applications, sets could be persistent as a default or optionally in response to user request.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

The described techniques may be implemented as a method, apparatus or article of manufacture involving software, firmware, micro-code, hardware and/or any combination thereof. The term “article of manufacture” as used herein refers to code or logic implemented in a medium, where such medium may comprise hardware logic [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. Additionally, the “article of manufacture” may comprise a combination of hardware and software components in which the code is embodied, processed, and executed. Of course, those skilled in the art will recognize that many modifications may be made without departing from the scope of embodiments, and that the article of manufacture may comprise any information bearing medium. For example, the article of manufacture comprises a storage medium having stored therein instructions that when executed by a machine results in operations being performed.

Certain embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article. The functionality and/or the features of a device may be alternatively embodied by one or more other devices which are not explicitly described as having such functionality/features. Thus, other embodiments need not include the device itself.

Computer program means or computer program in the present context mean any expression, in any language, code or notation, of a set of instructions intended to cause a system having an information processing device (e.g., CPU) to perform a particular function either directly or after either or both of the following a) conversion to another language, code or notation; b) reproduction in a different material form.

1. A method for defining sets of items in a data processing system, the items being visually represented in a graphical user interface of the system by respective graphical elements which are individually selectable via the graphical user interface to permit indication by a user of items on which actions are to be performed in the system, the method comprising:
receiving via the graphical user interface an indication of the graphical elements corresponding to items to be included in a set;
generating in the graphical user interface a graphical device which identifies the graphical elements corresponding to items in the set, the device being independent of the selection state of the elements, which remain individually selectable, and the set of items being independently selectable via the graphical user interface to permit actions to be performed on the set of items in the system; and
storing in the system set data defining the set of items;
the method being such that the same item can be a member concurrently of more than one said set for which the respective graphical devices concurrently identify the graphical element corresponding to that item.

2. A method according to claim 1 wherein the graphical device is independently selectable via the graphical user interface for selecting the set of items.

3. A method according to claim 1 wherein the same item can be a member concurrently of more than one set none of which is a subset of the other.

4. A method according to claim 1 wherein the graphical device comprises a frame extending around the elements corresponding to items in the set.

5. A method according to claim 2 wherein the graphical device comprises a frame extending around the elements corresponding to items in the set, the method including, in response to a user selecting and dragging the frame in the graphical user interface to change the set of elements contained in the frame, modifying the set data to redefine the set of items such that the set contains items corresponding to the changed set of elements contained in the frame.

6. A method according to claim 4 including, in response to a user selecting and dragging a graphical element into or out of the set of elements contained in the frame, modifying the set data to redefine the set of items such that the set contains items corresponding to the changed set of elements contained in the frame.

7. A method according to claim 1 wherein the graphical device comprises respective graphical indicators associated with the elements corresponding to items in the set.

8. A method according to claim 7 wherein a said graphical indicator comprises a frame around the associated element.

9. A method according to claim 7 including, in response to a user selecting and dragging a graphical element in a predetermined manner relative to the device to indicate desired movement of that element into or out of the set of elements currently identified by the device, modifying the set data to redefine the set of items as including or excluding, respectively, the item corresponding to that element.

10. A method according to claim 1 including adapting the graphical device to indicate when the set includes any items whose corresponding graphical elements are not currently viewable in the graphical user interface.

11. A method according to claim 1 including, at least when graphical devices for more than one set are currently viewable in the graphical user interface, highlighting a said device in the graphical user interface in response to interaction via the graphical user interface with the set corresponding to that device.

12. A method according to claim 1 wherein stored set data is discarded on shut-down of the data processing system.

13. A computer readable medium containing executable program instructions for causing a computer to perform a method for defining sets of items in a data processing system, the items being visually represented in a graphical user interface of the system by respective graphical elements which are individually selectable via the graphical user interface to permit indication by a user of items on which actions are to be performed in the system, the executable program instructions comprising instructions for:
receiving via the graphical user interface an indication of the graphical elements corresponding to items to be included in a set;
generating in the graphical user interface a graphical device which identifies the graphical elements corresponding to items in the set, the device being independent of the selection state of the elements, which remain individually selectable, and the set of items being independently selectable via the graphical user interface to permit actions to be performed on the set of items in the system; and
storing in the system set data defining the set of items;
wherein said method is such that the same item can be a member concurrently of more than one said set for which the respective graphical devices concurrently identify the graphical element corresponding to that item.

14. Apparatus for defining sets of items in a data processing system, the items being visually represented in a graphical user interface of the system by respective graphical elements which are individually selectable via the graphical user interface to permit indication by a user of items on which actions are to be performed in the system, the apparatus comprising memory and set management logic adapted for:
receiving via the graphical user interface an indication of the graphical elements corresponding to items to be included in a set;
generating in the graphical user interface a graphical device which identifies the graphical elements corresponding to items in the set, the device being independent of the selection state of the elements, which remain individually selectable, and the set of items being independently selectable via the graphical user interface to permit actions to be performed on the set of items in the system; and
storing in said memory set data defining the set of items;
wherein the set management logic is adapted such that the same item can be a member concurrently of more than one said set for which the respective graphical devices concurrently identify the graphical element corresponding to that item.

15. A data processing system comprising memory, a display for displaying a graphical user interface, control logic for controlling the graphical user interface such that items stored in said memory are visually represented in the graphical user interface by respective graphical elements which are individually selectable via the interface to permit indication by a user of items on which actions are to be performed in the data processing system, and an input system for user input to interact with the graphical user interface, wherein the control logic includes set management logic for defining sets of items represented by elements in the graphical user interface, the set management logic being adapted for:
receiving via the graphical user interface an indication of the graphical elements corresponding to items to be included in a set;
generating in the graphical user interface a graphical device which identifies the graphical elements corresponding to items in the set, the device being independent of the selection state of the elements, which remain individually selectable, and the set of items being independently selectable via the graphical user interface to permit actions to be performed on the set of items in the system; and
storing in said memory set data defining the set of items;
wherein the set management logic is adapted such that the same item can be a member concurrently of more than one said set for which the respective graphical devices concurrently identify the graphical element corresponding to that item.
